(19) United States
(12) Patent Application Publication
(10) Pub. No.: US 2024/0247678 A1
(43) Pub. Date: Jul. 25, 2024

(54) STOP TURN FITTING

(71) Applicants: Justin Priest, Mount Vernon, WA (US); Truong Ma, Everett, WA (US); Brandon Singh, Maple Valley, WA (US); Kornel Cieslik, Everett, WA (US); Ephraim Carter, Stanwood, WA (US)

(72) Inventors: Justin Priest, Mount Vernon, WA (US); Truong Ma, Everett, WA (US); Brandon Singh, Maple Valley, WA (US); Kornel Cieslik, Everett, WA (US); Ephraim Carter, Stanwood, WA (US)

(21) Appl. No.: 18/100,161

(22) Filed: Jan. 23, 2023

(51) Int. Cl. F16B 39/28

(52) U.S. Cl. CPC F16B 39/28; F16B 2200/503

(57) ABSTRACT

The presently disclosed fitting stop turn device includes a fitting retainer plate and a backer plate that provide a clamping mechanism to a fitting that passes through a partition such that the fitting retainer plate and backing plate prevent axial rotation of the fitting positioned through the partition. The fitting retainer plate secures the fitting on a first side of the partition and abuts a first side of the partition, while the backer plate abuts a second side of the partition. The retainer plate and backer plate are held in their respective positions against the partition by one or more fasteners that traverse the retainer plate, the partition, and the backer plate.

### CROSS-REFERENCE TO RELATED APPLICATION

This application claims the benefit of U.S. Provisional Application No. 63/302,113 filed on Jan. 23, 2022, which is incorporated by reference in its entirety.

### FIELD OF THE INVENTION

The invention relates to a device that provides a restrictive force to a fitting that can otherwise rotate along its own axis through a partition, such that the device holds a fastening element and prevents free spinning motion of the fitting.

### BACKGROUND

The incorporation of fasteners into an unthreaded partition requires such fasteners to have a restrictive element on the other side of the partition to aid in providing compressive force, such as a nut or other threaded medium. When tightening fasteners to provide adequate compressive force on opposing sides of a partition, the nut or threaded medium is prone to free spin.

A common approach to addressing this issue of free spin is to have a second person or party use a wrench, ratchet, or similar device to hold the nut or threaded medium in place on one side of the partition while a first person or party tightens the fitting (such as a bolt) on the other side of the partition. Other common approaches involve an individual user solely attempting to prevent the free spinning, rotational translation of a fitting and a fastener/nut with various mounting and positioning of tools/devices by awkwardly placing tools such as wrenches, drivers, and sockets on one side of a partition while trying to tighten a fastener on the other side of the partition.

Accordingly, there is a need in the art for an approach to tightening fasteners through an unthreaded partition that reduces or eliminates the need of a second party as well as the awkward configuration of tools that may or may not hold their position when used by a solo user. The presently disclosed device addresses this need.

### SUMMARY

The presently disclosed fitting stop turn device is designed to prevent axial rotation of an AN or similar fitting placed through a partition. The stop turn device includes a first bracket member secured to a fitting placed through a partition, the first bracket member abutting a first side of the partition; a second bracket member through which the fitting passes through, the second bracket member abutting a second side of the partition; whereby the first and second brackets impart a clamping mechanism that prevents axial rotation of the fitting.

In a preferred embodiment, a fitting stop turn device for prevention of axial rotation of an AN fitting placed through a partition includes a female type AN fitting retainer plate secured to a male type AN fitting placed through a partition, the female type AN fitting retainer plate abutting a first side of the partition; a female type backer plate through which the male type AN fitting passes through, the female type backer plate abutting a second side of the partition; whereby the retainer plate is secured to the backer plate by one or more fasteners that traverse through the retainer plate, the partition, and the backer plate such the retainer plate and backer plate are configured to prevent axial rotation of the fitting.

In another preferred embodiment, a fitting stop turn device for prevention of axial rotation of an AN fitting placed through a partition includes a female type AN fitting retainer plate secured to a male type AN fitting placed through a partition, the female type AN fitting retainer plate abutting a first side of the partition; whereby the fitting retainer plate has an opening shaped to engage an outer shape of a fastener positioned over a first end of the AN fitting; a female type backer plate through which the male type AN fitting passes through, the female type backer plate abutting a second side of the partition; whereby the retainer plate is secured to the backer plate by one or more fasteners that traverse through the retainer plate, the partition, and the backer plate such that the retainer plate and backer plate impart a clamping mechanism to prevent axial rotation of the AN fitting.

The presently disclosed fitting stop turn device is more fully described in the drawings presented herein and the detailed description below.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 shows a perspective view of a fitting retainer plate according to exemplary embodiments hereof.

FIG. 2 shows a perspective view of a backing plate according to exemplary embodiments hereof.

FIG. 3 shows a side view of an AN fitting according to exemplary embodiments hereof.

FIG. 4 shows an exploded view of a fitting retainer plate, an AN fitting, and a backing plate relative to a partition according to exemplary embodiments hereof.

FIG. 5 shows a side view of a fitting retainer plate, an AN fitting, and a backing plate on a partition according to exemplary embodiments hereof.

FIG. 6 shows a perspective view of an installed stop turn fitting retainer plate and an AN fitting according to exemplary embodiments hereof.

### DETAILED DESCRIPTION OF EXEMPLARY EMBODIMENTS

A fitting stop turn device (also referred to as a stop turn fitting) as disclosed herein will become better understood through a review of the following detailed description in conjunction with the figures. The detailed description and figures provide merely examples of the various embodiments of a stop turn fitting. Many variations are contemplated for different applications and design considerations; however, for the sake of brevity and clarity, all the contemplated variations may not be individually described in the following detailed description. Those skilled in the art will understand how the disclosed examples may be varied, modified, and altered and not depart in substance from the scope of the examples described herein.

Conventional approaches for installing an AN fitting or similar fitting into an unthreaded partition include using two people or parties to install the AN fitting into the partition, since the AN fitting is prone to freely spin in the unthreaded partition while trying to tighten a fastener to hold the AN fitting in the partition. In particular, a fastening nut or similar threaded medium on a second side of a partition will spin or rotate with the AN fitting while a fastener is tightened on a first side of a partition. Accordingly, a first person will tighten a nut or similar fastener on the AN fitting on a first side of a partition while a second person will hold a fastener/nut on the AN fitting on a second side of the partition so that a compressive force can be applied and secure the AN fitting in place.

As an alternative to using two people for installing an AN fitting into an unthreaded partition, conventional approaches include a single person installing an AN fitting. These approaches typically involve mounting and positioning of tools/devices as solutions to prevent rotational translation of a fastener/nut, in which tools such as wrenches, drivers, sockets and so on are mounted or positioned to hold a nut on an AN fitting on a second side of a partition while a person tightens a fastener on an AN fitting on a first side of the partition.

The two-person approach described above suffers from the inconvenience that two people are required for the installation of an AN fitting into a partition, thereby precluding a single person from being able to install an AN fitting.

Likewise, the single-person approach described above has the drawback that the mounting and positioning of a tool/device on a second side of a partition while a person tightens on a first side of the partition is far from fail safe. The mounting and positioning of the tool/device can be awkward and is prone to having the tool/device move or fall out of position on one side of a partition while the person tries to tighten a fastener to the AN fitting from the other side of the partition.

Implementation of a stop turn fitting may address some or all of the problems described above. A stop turn fitting includes a fitting retainer plate for an AN fitting and a backer plate that provide mounting and positioning for a male fitting and a clamping mechanism that holds the AN fitting and a fastener/nut in place. In particular, the AN retainer plate and backer plate work to hold a fastening nut or similar threaded medium in place on an AN fitting on a second side of a partition so that a single person or party can tighten a fastener on the AN fitting on a first side of the partition. The stop turn fitting thereby eliminates the need for a second person or party to install an AN fitting. Likewise, the stop turn fitting eliminates the need for any tools or devices, such as a wrench, socket, etc. on the second side of a partition, such that a single person can tighten a fastener to an AN fitting on the first side of a partition without the awkward mounting or positioning of a tool/device on the second side of the partition.

In particular, the stop turn fitting includes a female type retainer plate that is configured to engage with a fastener on a male type AN fitting that is inserted into a partition, such that the retainer plate engages the fastener and abuts a second side of the partition. The female type retainer plate has an opening that is shaped to engage and fit over the outer shape of a fastener on a male type AN fitting on a second side of a partition. For example, the female type retainer plate can have a hexagonal opening that fits over a hexagonal nut/fastener on the male type AN fitting.

The female type backer plate has an opening that allows a male type AN fitting to pass through the backer plate. The female type backer plate is positioned on a first side of a partition, such that it abuts the first side of the partition. The stop turn fitting that includes the retainer plate and the backer plate on opposite sides of the partition is held in place by one or more fasteners (such as machine screws) that traverse the retainer plate, the partition, and the backer plate. Accordingly, the retainer plate, the partition, and backer plate have holes that align to allow a fastener, such as a machine screw, to be screwed through the retainer plate and partition into the backer plate, such that the fastener holds the stop turn fitting in place on the partition.

As used herein, the term “partition” refers to a partition or divider that separates a space into a first side and a second side. A partition accordingly includes a partition, a bulkhead, a firewall, or any other structure that requires a pass-through fitting. Typically, the partition is unthreaded, such that a fitting that passes through the partition can freely rotate axially while inserted into in the partition.

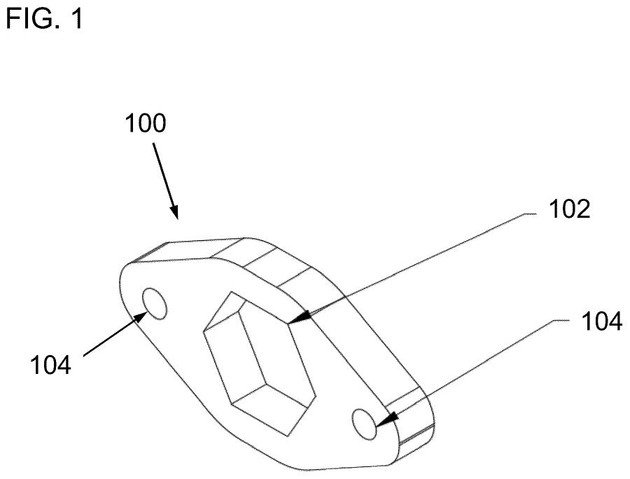

FIG. 1 illustrates a perspective view of a fitting retainer plate 100, according to an embodiment. The female inserts 102 and 104 may retain a plurality of male inserting elements. In a preferred embodiment, the fitting retainer plate 100 is produced as a single piece (as shown in FIG. 1). The female insert 102 is shaped to engage the outer shape of fastener/nut that is placed on a male AN fitting (or similar fitting). The female insert(s) 104 is an opening through which a fastener (such as a machine screw or similar fastener) can pass through to hold the fitting retainer plate 100 in place against a partition. The fitting retainer plate 100 can be positioned horizontally on a partition and scaled to fit the size of the male inserting element it will engage with. Likewise, the fitting retainer plate 100 can be positioned vertically on the partition and scaled for a particular size/fit. The fitting retainer plate 100 preferably has an overall, outer diamond geometrical shape, but other geometrical shapes that maintain the fitting retainer plate 100 function may also be used. The fitting retainer plate 100 can be made of aluminum, steel, another metal, carbon fiber, plastic, resin, glass-filled plastic, rubber, and other various materials suitable for the fitting retainer plate 100 application. In one embodiment, the fitting retainer plate 100 is made of aluminum.

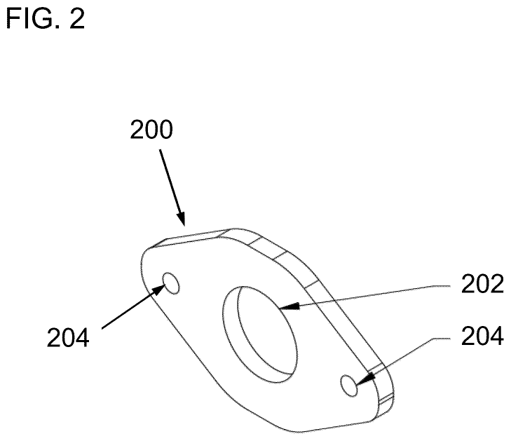

FIG. 2 illustrates a shows a perspective view of a backer plate 200, according to an embodiment. The female inserts 202 and 204 may retain a plurality of male inserting elements. In particular, the female insert 202 provides an opening through which a male AN fitting (or similar fitting) can pass through. The female insert(s) 204 is an opening into which a fastener (such as a machine screw or similar fastener) can screw into place to hold the backer plate 200 in place against a partition. In a preferred embodiment, the backer plate 200 is produced as a single piece (as shown in FIG. 2). The backer plate 200 can be positioned horizontally and scaled to fit the size of the male inserting element it will engage with. Likewise, the backer plate 200 can be positioned vertically and scaled for a particular size/fit. The backer plate 200 preferably has an overall diamond geometrical shape, but other geometrical shapes that maintain the backer plate 200 function may also be used. The backer plate 200 can be made of aluminum, steel, another metal, carbon fiber, plastic, resin, glass-filled plastic, rubber, and other various materials suitable for the backer plate 200 application. In one embodiment, the backer plate 200 is made of plastic.

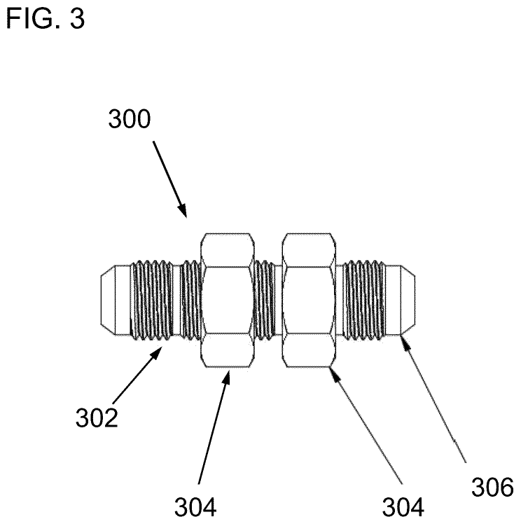

FIG. 3 illustrates a side view of an AN fitting 300, according to an embodiment. The male insert 302 and its fasteners/nuts 304 can be scaled to fit the size of female brackets that it will engage with. The tightening fasteners/nuts 304 (or similar threaded medium) in use are tightened to lock the AN fitting 300 in place in a partition by providing compressing force between the fasteners/nuts 304 and the partition. The male insert 302 preferably has a chamfered insert 306 with a slightly smaller diameter to engage in a non-interference fit with the female elements in the fitting retainer plate and backer plate as described above and shown in FIGS. 1 and 2 (see 102 and 202). As described herein, the stop turn fitting holds the AN fitting 300 in place so that it can be tightened by a single person or user on one side of a partition.

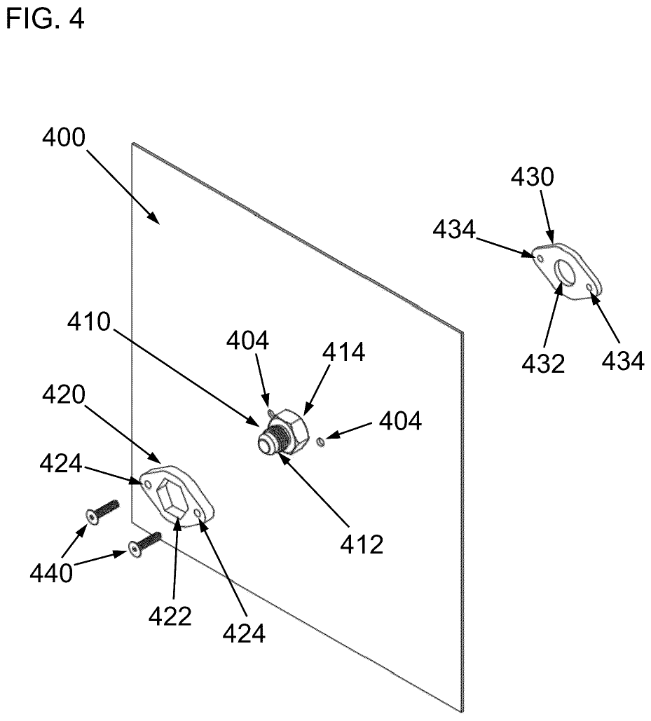

FIG. 4 illustrates an exploded view of a stop turn fitting (fitting retainer plate and backer plate), an AN fitting, and a partition, according to an embodiment. As shown in FIG. 4, a partition 400 has an AN fitting 410 inserted into the partition 400 (in a female element/hole in the partition, which is filled with the AN fitting 410). The AN fitting 410 has a male insert 412 to which a fastener/nut 414 is threaded onto the male insert 412. The AN fitting 410 is positioned such that the fastener/nut 414 will align with a female insert 422 in the fitting retainer plate 420 when the fitting retainer plate 420 is placed over the AN fitting 410. The female insert 422 of the fitting retainer plate 420 is shaped to engage with the outer shape of the fastener/nut 414 on the male AN fitting 410. In the example shown in FIG. 4, the female insert 422 has a hexagonal shape to engage the hexagonal fastening nut 414. The fitting retainer plate 420 has additional female elements 424 that align with holes 404 in the partition. Likewise, the backer plate 430 has a female element 432 that a male portion of the AN fitting will pass through and female elements 434 that will align with holes 404 in the partition. Accordingly, the fitting retainer plate female elements 424, partition holes 404, and backing plate female elements 434 align so that they receive machine screws 440 (or similar fasteners) that thread through the fitting retainer plate 420, partition 400, and backing plate 430 to hold the fitting retainer plate 420 against one side of the partition 400 and hold the backing plate 430 against the other side of the partition. In this manner, the machine screws 440 secure the stop turn fitting in place.

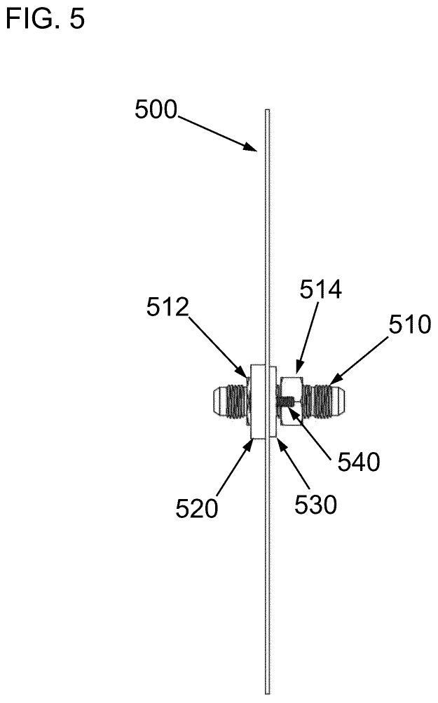

FIG. 5 illustrates a side view of an AN fitting secured to a partition by a stop turn fitting (fitting retainer plate and backing plate), according to an embodiment. As shown in FIG. 5, a partition 500 has an AN fitting 510 inserted into the partition 500. An AN fitting retainer plate 520 is placed on one side of the partition 500 and is engaged with the AN fitting fastening nut 512, such that the AN fitting retainer plate 520 clamps the AN fitting fastening nut 512 in place against the partition and prevents the AN fitting nut 512 from axially rotating/spinning. On the other side of the partition 500 lies the backer plate 530, which is the second portion of the AN fitting clamping mechanism. The fitting retainer plate 520 and backing plate 530 are held in place by machine screws 540 (or similar fasteners) that traverse the fitting retainer plate 520, partition 500, and backing plate 530. A portion of a machine screw 540 is shown protruding out from the backing plate 520 in FIG. 5. The engagement of the fitting retainer plate 520 with the AN fitting fastening nut 512 combined with the assembly of the fitting retainer plate 520 and backing plate 530 on opposite sides of the partition 500 provides a clamping mechanism such that the AN fitting 510 cannot axially rotate. Accordingly, a force can be applied to the AN fitting 510 without it spinning in place. Such force typically will involve turning of the AN fitting fastening nut 514, which can be turned without the AN fitting spinning. In this manner, a single person or user can work on the AN fitting 510 on one side of the partition 500 without any assistance of a second person or any tools on the other side of the partition 500. Likewise, force can be applied to a clamped AN fitting 510 in the form of lines that may be attached to (or removed from) the AN fitting 510 without the requirement of a second person or second set of hands to install or uninstall the lines.

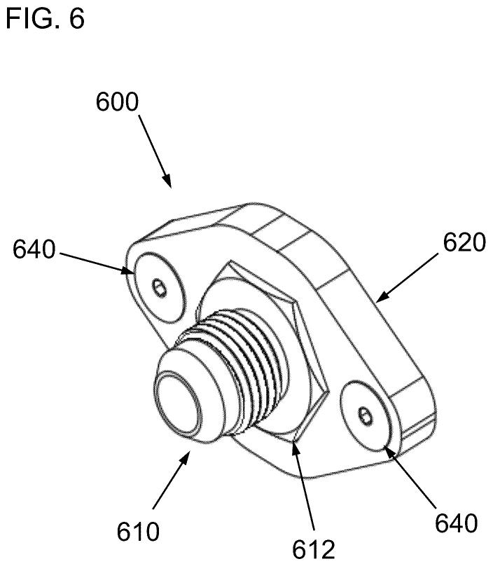

FIG. 6 illustrates a perspective view of a portion of an installed stop turn fitting (an installed AN fitting and fitting retainer plate), according to an embodiment. As shown in FIG. 6, an installed stop turn fitting 600 has a fitting retainer plate 620 positioned around an AN fitting 610, such that a female opening in the fitting retainer plate 620 engages with a fastening nut 612 positioned on the male AN fitting 610. The fitting retainer plate 620 is held in place by machine screws 640 (or similar fasteners) that are inserted/screwed through the fitting retainer plate 620. The machine screws 640 traverse through the fitting retainer plate 620, the partition (not shown), and into/through the backer plate (not shown). The installed stop turn fitting 600 secures the male AN fitting 610 and fastening nut 612 on one side of a partition so that a single person or user can work on the AN fitting 610 on the other side of the partition.

The stop turn fitting described herein is preferably applicable for use with AN fittings. As such, the stop turn fitting can be sized and configured to accommodate any AN fitting, such as but not limited to, standard AN fittings ranging from −2 (dash 2) to-32 (dash 32).

While the stop turn fitting described herein is applicable for use with AN fittings, the stop turn fitting is not limited to AN fittings. The stop turn fitting can be sized and shaped to accommodate any type of fitting that suffers from the propensity to axially rotate or spin when placed through a hole in an unthreaded partition.

A stop turn fitting can be installed by any applicable method that results in the stop turn fitting clamping an AN fitting (or similar fitting) in place. In a preferred embodiment, the following steps are employed in the installation of a stop turn fitting. Initially, a location for installation of a stop turn fitting on a partition (such as a bulkhead or firewall) is determined. Next, clearance holes for the AN fitting and the fasteners are located and created. Once the holes are created in the partition, an AN fitting is placed through the partition, with a fitting fastening nut on the AN fitting that will lie against a first side of the partition. The backer plate is then placed over the AN fitting on the other, second side of the partition, aligned with the clearance holes for the machine screws, and then secured in place with a fitting nut to hold the backer plate against the partition. Next, the fitting nut on the first side of the partition is rotated so that the fitting retainer plate can be placed over the fitting fastening nut with the clearance holes of the fitting retainer plate aligned with the clearance holes in the partition. The fitting retainer plate and backer plate are then secured in place by inserting machine screws (or similar fasteners) through the fitting retainer plate screw holes, through the partition clearance holes, and into the screw receiving holes in the backer plate. Preferably, the machine screws are treated with a threadlocker, such as Loctite®, to help prevent loosening of the machine screws from vibration or similar movement. The stop turn fitting is now installed, such that the AN fitting cannot axially rotate or spin. The AN fitting on the second side of the partition (on the backer plate side) can then be tightened/manipulated as desired. Finally, completion of the AN fitting installation allows for lines to be attached to the AN fitting.

A feature illustrated in one of the figures may be the same as or similar to a feature illustrated in another of the figures. Similarly, a feature described in connection with one of the figures may be the same as or similar to a feature described in connection with another of the figures. The same or similar features may be noted by the same or similar reference characters unless expressly described otherwise. Additionally, the description of a particular figure may refer to a feature not shown in the particular figure. The feature may be illustrated in and/or further described in connection with another figure.

Elements of processes (i.e. methods) described herein may be executed in one or more ways such as by a human, by a processing device, by mechanisms operating automatically or under human control, and so forth. Additionally, although various elements of a process may be depicted in the figures in a particular order, the elements of the process may be performed in one or more different orders without departing from the substance and spirit of the disclosure herein.

The foregoing description sets forth numerous specific details such as examples of specific systems, components, methods and so forth, in order to provide a good understanding of several implementations. It will be apparent to one skilled in the art, however, that at least some implementations may be practiced without these specific details. In other instances, well-known components or methods are not described in detail or are presented in simple block diagram format in order to avoid unnecessarily obscuring the present implementations. Thus, the specific details set forth above are merely exemplary. Particular implementations may vary from these exemplary details and still be contemplated to be within the scope of the present implementations.

Related elements in the examples and/or embodiments described herein may be identical, similar, or dissimilar in different examples. For the sake of brevity and clarity, related elements may not be redundantly explained. Instead, the use of a same, similar, and/or related element names and/or reference characters may cue the reader that an element with a given name and/or associated reference character may be similar to another related element with the same, similar, and/or related element name and/or reference character in an example explained elsewhere herein. Elements specific to a given example may be described regarding that particular example. A person having ordinary skill in the art will understand that a given element need not be the same and/or similar to the specific portrayal of a related element in any given figure or example in order to share features of the related element.

It is to be understood that the foregoing description is intended to be illustrative and not restrictive. Many other implementations will be apparent to those of skill in the art upon reading and understanding the above description. The scope of the present implementations should, therefore, be determined with reference to the appended claims, along with the full scope of equivalents to which such claims are entitled.

The foregoing disclosure encompasses multiple distinct examples with independent utility. While these examples have been disclosed in a particular form, the specific examples disclosed and illustrated above are not to be considered in a limiting sense as numerous variations are possible. The subject matter disclosed herein includes novel and non-obvious combinations and sub-combinations of the various elements, features, functions and/or properties disclosed above both explicitly and inherently. Where the disclosure or subsequently filed claims recite “a” element, “a first” element, or any such equivalent term, the disclosure or claims is to be understood to incorporate one or more such elements, neither requiring nor excluding two or more of such elements.

As used herein “same” means sharing all features and “similar” means sharing a substantial number of features or sharing materially important features even if a substantial number of features are not shared. As used herein “may” should be interpreted in a permissive sense and should not be interpreted in an indefinite sense. Additionally, use of “is” regarding examples, elements, and/or features should be interpreted to be definite only regarding a specific example and should not be interpreted as definite regarding every example. Furthermore, references to “the disclosure” and/or “this disclosure” refer to the entirety of the writings of this document and the entirety of the accompanying illustrations, which extends to all the writings of each subsection of this document, including the Title, Background, Brief description of the Drawings, Detailed Description, Claims, Abstract, and any other document and/or resource incorporated herein by reference.

As used herein regarding a list, “and” forms a group inclusive of all the listed elements. For example, an example described as including A, B, C, and D is an example that includes A, includes B, includes C, and also includes D. As used herein regarding a list, “or” forms a list of elements, any of which may be included. For example, an example described as including A, B, C, or D is an example that includes any of the elements A, B, C, and D. Unless otherwise stated, an example including a list of alternatively-inclusive elements does not preclude other examples that include various combinations of some or all of the alternatively-inclusive elements. An example described using a list of alternatively-inclusive elements includes at least one element of the listed elements. However, an example described using a list of alternatively-inclusive elements does not preclude another example that includes all of the listed elements. And, an example described using a list of alternatively-inclusive elements does not preclude another example that includes a combination of some of the listed elements. As used herein regarding a list, “and/or” forms a list of elements inclusive alone or in any combination. For example, an example described as including A, B, C, and/or D is an example that may include: A alone; A and B; A, B and C; A, B, C, and D; and so forth. The bounds of an “and/or” list are defined by the complete set of combinations and permutations for the list.

Where multiples of a particular element are shown in a FIG., and where it is clear that the element is duplicated throughout the FIG., only one label may be provided for the element, despite multiple instances of the element being present in the FIG. Accordingly, other instances in the FIG. of the element having identical or similar structure and/or function may not have been redundantly labeled. A person having ordinary skill in the art will recognize based on the disclosure herein redundant and/or duplicated elements of the same FIG. Despite this, redundant labeling may be included where helpful in clarifying the structure of the depicted examples.

The Applicant(s) reserves the right to submit claims directed to combinations and sub-combinations of the disclosed examples that are believed to be novel and non-obvious. Examples embodied in other combinations and sub-combinations of features, functions, elements and/or properties may be claimed through amendment of those claims or presentation of new claims in the present application or in a related application. Such amended or new claims, whether they are directed to the same example or a different example and whether they are different, broader, narrower or equal in scope to the original claims, are to be considered within the subject matter of the examples described herein.

1. A fitting stop turn device for prevention of axial rotation of a fitting placed through a partition, the fitting stop turn device comprising:
a first bracket member secured to a fitting placed through a partition, the first bracket member abutting a first side of the partition;
a second bracket member through which the fitting passes through, the second bracket member abutting second side of the partition;
wherein the first and second brackets prevent axial rotation of the fitting placed through the partition.

2. The fitting stop turn device of claim 1, wherein the first bracket member is secured to the second member by one or more fasteners that traverse through the first bracket member, the partition, and the second bracket member.

3. The fitting stop turn device of claim 2, wherein the one or more fasteners are one or more machine screws.

4. The fitting stop turn device of claim 1, wherein the first bracket member is configured to engage with a fitting fastener positioned over a first end of the fitting.

5. The fitting stop turn device of claim 4, wherein the first bracket member has an opening shaped to engage an outer shape of the fitting fastener positioned over a first end of the fitting.

6. The fitting stop turn device of claim 5, wherein the first bracket member has a polygonal opening shaped to engage a polygonal outer shape of the fitting fastener positioned over a first end of the fitting.

7. The fitting stop turn device of claim 1, wherein the first and second bracket members are formed from a material selected from the group consisting of aluminum, steel, plastic, resin, glass-filled plastic, carbon fiber, rubber, or a combination thereof.

8. The fitting stop turn device of claim 1, wherein the first and second brackets are formed of aluminum.

9. The fitting stop turn device of claim 1, wherein the fitting is an AN fitting.

10. The fitting stop turn device of claim 1, wherein the first bracket member comprises a female type retainer plate;
the second bracket member comprises a female type backer plate; and
the fitting comprises a male type insert.

11. The fitting stop turn device of claim 10, wherein the fitting comprises a male type insert AN fitting.

12. A fitting stop turn device for prevention of axial rotation of an AN fitting placed through a partition, the fitting stop turn device comprising:
a female type AN fitting retainer plate secured to a male type AN fitting placed through a partition, the female type AN fitting retainer plate abutting a first side of the partition;
a female type backer plate through which the male type AN fitting passes through, the female type backer plate abutting a second side of the partition; and
wherein the retainer plate is secured to the backer plate by one or more fasteners that traverse through the retainer plate, the partition, and the backer plate;
wherein the retainer plate and backer plate prevent axial rotation of the fitting placed through the partition.

13. The fitting stop turn device of claim 12, wherein the one or more fasteners are one or more machine screws.

14. The fitting stop turn device of claim 12, wherein the retainer plate has an opening shaped to engage an outer shape of a fitting fastener positioned over a first end of the male type AN fitting.

15. The fitting stop turn device of claim 14, wherein the retainer plate has a polygonal opening shaped to engage a polygonal outer shape of the fitting fastener positioned over a first end of the male type AN fitting.

16. The fitting stop turn device of claim 12, wherein the retainer plate and backer plate are formed from a material selected from the group consisting of aluminum, steel, plastic, resin, glass-filled plastic, carbon fiber, rubber, or a combination thereof.

17. The fitting stop turn device of claim 12, wherein the retainer plate and backer plate are formed of aluminum.

18. A fitting stop turn device for prevention of axial rotation of an AN fitting placed through a partition, the fitting stop turn device comprising:
a female type AN fitting retainer plate secured to a male type AN fitting placed through a partition, the female type AN fitting retainer plate abutting a first side of the partition;
wherein the fitting retainer plate has an opening shaped to engage an outer shape of a fitting fastener positioned over a first end of the AN fitting;
a female type backer plate through which the male type AN fitting passes through, the female type backer plate abutting a second side of the partition; and
wherein the retainer plate is secured to the backer plate by one or more fasteners that traverse through the retainer plate, the partition, and the backer plate;
wherein the retainer plate and backer plate prevent axial rotation of the AN fitting placed through the partition.

19. The fitting stop turn device of claim 18, wherein the female type retainer plate has a polygonal opening shaped to engage a polygonal outer shape of the fitting fastener positioned over a first end of the male type AN fitting.

20. The fitting stop turn device of claim 18, wherein the retainer plate and backer plate are formed from a material selected from the group consisting of aluminum, steel, plastic, resin, glass-filled plastic, carbon fiber, rubber, or a combination thereof.
